(19) United States
(12) Patent Application Publication
(10) Pub. No.: US 2023/0334164 A1
(43) Pub. Date: Oct. 19, 2023

(54) DOCUMENT REDACTED PART DISPLAYING SYSTEM, DOCUMENT REDACTED PART DISPLAYING METHOD, AND PROGRAM

(71) Applicant: NEC Corporation, Minato-ku, Tokyo (JP)

(72) Inventors: Takashi OIKAWA, Tokyo (JP); Takanori KOBAYASHI, Tokyo (JP); Akihisa TSUDA, Tokyo (JP); Hisashi NAGAI, Tokyo (JP)

(73) Assignee: NEC Corporation, Minato-ku, Tokyo (JP)

(21) Appl. No.: 18/007,761

(22) PCT Filed: Jun. 3, 2020
(86) PCT No.: PCT/JP2020/021904

§ 371 Date: Dec. 2, 2022

(51) Int. Cl. G06F 21/62; G06N 3/091

(52) U.S. Cl. CPC G06F 21/6218; G06N 3/091

(57) ABSTRACT

A document redacted part displaying system includes: a redaction target document determining part which determines a redaction target document which entails an inputted text; a trained model generation part which generates a trained model by training a model using one or more documents and labels that designates a redacted part(s) in the document(s) as training data; a redaction part prediction part which predicts and outputs a part(s) to be redacted in the redaction target document by the trained model; and a redacted part displaying part which displays the redacted part(s) in the redaction target document.

### FIELD

The present invention relates to a document redacted part displaying system, a document redacted part displaying method, and program.

### BACKGROUND

Patent Literature (PTL) 1 discloses an information sharing system which has a security module part 113 to identify feature information whose access right data indicates accessible as disclosable feature information. According to PTL 1, in paragraph 0050, it is disclosed that “The access right table 116 of the feature information as indicated in FIG. 5a is an example in which the access right of the feature information is associated with and set to the document security attribute information. The access right table 116 of the feature information as indicated in FIG. 5b is an example in which the access right of the feature information is associated with and set to each of documents.” In paragraph 0051, it is disclosed that “In the access right table 116 of the feature information, a document security attribute 401 indicates security attribute information assigned to document data. Furthermore, the feature information 402 indicates the access right of each feature type 403 in the feature information extracted from the document data. Furthermore, the feature type 403 is an index by which the feature information 402 is classified. Further, the neighborhood display 404 indicates whether or not the neighborhood data may be displayed.”

PTL 2 discloses an information disclosure program which enables to perform operations to prepare documents to be disclosed, even if not knowing information to be concealed and information not allowed to be concealed. According to PTL 2, in paragraph 0011, it is disclosed that “The auxiliary storage device 8 of the server 1 further stores a master document 12, a document to be disclosed 13, a non-disclosure dictionary 14, a forcible disclosure dictionary 15, and a comment dictionary 16.” In paragraph 0012, it is described that “ . . . generates a . . . master document 12. A non-disclosure tag and a reason for non-disclosure are given to a character string to be concealed in the master document 12.” In paragraph 0013, it is described that “By executing a forced disclosure program 10 on a master document 12 generated by a documenter, an examiner changes a character string to be forcibly disclosed among character strings indicated to be undisclosed in the master document 12 to a target of disclosure. After confirming the accuracy of what should be disclosed and what is not disclosed, . . . to generate the disclosure document 13.” In paragraph 0014, it is described that “A user causes the document to be disclosed 13 to display on a display of a user terminal device 4 and views it.”

PTL 3 discloses to provide a disclosing document preparation supporting apparatus, which is capable of reducing the load for identifying a concealed specific part and supporting the preparation of the public document that can certainly reflects a result of decision. According to PTL 3, in paragraph 0018, it is disclosed that “ . . . the hard disk 14 keeps a character string search condition table T1 as shown in FIG. 3 and a concealment candidate image area data table T2 as shown in FIG. 4.” In paragraph 0019, it is disclosed that “As shown in FIG. 3, the character string search condition table T1 enumerates predetermined character strings to be searched for each category of information not to be disclosed. Here, as categories of information not to be disclosed, “personal information” and “national security information”, and so on are shown . . . ”. In paragraph 0024, it is disclosed that “if there is a matching part (Yes), the character string is set to be highlighted in a specified manner for the category to which the character string is belongs to (S 7), . . . ”. In paragraph 0046, it is disclosed that “In the disclosing document preparation supporting apparatus 1 receives the document data after decision and output it to the printer 3 to print out the document data to be disclosed. At this time, the part marked with the concealment annotation becomes to a redacted state.”

PTL 4 discloses an entailment determination method including: extracting, for each of a plurality of single sentences included in a hypothesis text, single sentences each of which has a similar meaning to each of the single sentences included in the hypothesis text, from a target text including a plurality of single sentences:
generating discourse relation information indicating a discourse relation which is an occurrence order of events between single sentences based on the appearance order of single sentences before and after a certain connection word for each of the hypothesis text and the target text:
calculating, based on the discourse relation information, a discourse relation distance which is the number of intersections of positions between the discourse relation between the single sentences included in the hypothesis text and the single sentences extracted by the extraction part: and
determining, based on a value including the discourse relation distance and a predetermined threshold value, whether or not the target text entails the hypothesis text.

### CITATION LIST

### Patent Literature

PTL 1: Japanese Patent Kokai Publication No. JP2010-272082A
PTL 2: Japanese Patent Kokai Publication No. JP2004-118599A
PTL 3: Japanese Patent Kokai Publication No. JP2003-132056A
PTL 4: Japanese Patent No. JP6578941B

### SUMMARY

### Technical Problem

The following analysis has been given from a view of the present invention. One of services by the public agency such as the government and organizations, for example the central government, is a response to a requester for an information disclosure request. Although it is necessary to redaction unnecessary items in a disclosure target document when responding to the requester, there is a problem that a large amount of time and much effort are required to do it.

It is an object of the present invention to provide a document redacted part displaying system, a document redacted part displaying method, and program which contribute to improve efficiency of redaction operations of a document.

### Solution to Problem

According to a first aspect, there is provided a document redacted part displaying system, including:
a redaction target document determining part which determines a redaction target document which entails an inputted text;
a trained model generation part which generates a trained model by training a model using one or more documents and labels that designates a redacted part(s) in the document(s) as training data;
a redaction part prediction part which predicts and outputs a part(s) to be redacted in the redaction target document by the trained model; and
a redacted part displaying part which displays the redacted part(s) in the redaction target document.

According to a second aspect, there is provided a document redacted part displaying method, comprising:
a step of determining a redaction target document which entails an inputted text;
a step of generating a trained model by training a model using one or more documents and labels that designates a redacted part(s) in the document(s) as training data;
a prediction step of predicting and outputting a part(s) to be redacted in the redaction target document by the trained model; and
a step of displaying the redacted part(s) in the redaction target document. The present method is tied to a particular machine, namely, a computer which includes functions to determine a redaction target document, generate a trained model, predict and output a part(s) to be redacted, and display the redacted part(s) as described above.

According to a third aspect, there is provided a program that causes a computer comprising a processor and a memory to execute processings, including:
determining a redaction target document which entails an inputted text;
generating a trained model by training a model using one or more documents and labels that designates a redacted part(s) in the document(s) as training data;
predicting and outputting a part(s) to be redacted in the redaction target document by the trained model; and
displaying the redacted part(s) in the redaction target document. It is to be noted that these programs can be recorded on a computer-readable (non-transitory) storage medium. Namely, the present invention can be implemented as a computer program product.

### Advantageous Effects of Invention

According to the present invention, it is possible to contribute to improve efficiency of redaction operations of a document.

### BRIEF DESCRIPTION OF DRAWINGS

FIG. 1 is a diagram illustrating a configuration of a document redacted part displaying system according to an example embodiment of the present invention.

FIG. 2 is a diagram illustrating an operation of a redacted part displaying part of the document redacted part displaying system according to the example embodiment of the present invention.

FIG. 3 is a diagram illustrating a configuration of a document redacted part displaying system according to a first example embodiment of the present invention.

FIG. 4 is a diagram illustrating a configuration of a text entailment recognition part of the document redacted part displaying system according to the first example embodiment of the present invention.

FIG. 5 is a diagram illustrating a configuration of a trained model generation part of the document redacted part displaying system according to the first example embodiment of the present invention.

FIG. 6 is a diagram illustrating a configuration of a redaction processing part of the document redacted part displaying system according to the first example embodiment of the present invention.

FIG. 7 is a diagram illustrating a configuration of a part to extract part to be redacted of the document redacted part displaying system according to the first example embodiment of the present invention.

FIG. 8 is a diagram illustrating a configuration of a document redacted part displaying system according to a second example embodiment of the present invention.

FIG. 9 is a diagram illustrating a flow chart describing an operation of the document redacted part displaying system according to the second example embodiment of the present invention.

FIG. 10 is a diagram illustrating a flow chart describing an operation of the document redacted part displaying system according to the second example embodiment of the present invention.

FIG. 11 is a diagram illustrating a configuration of a document redacted part displaying system according to a third example embodiment of the present invention.

FIG. 12 is a diagram illustrating a configuration of a redaction processing part and a redacted part change/reason display/list display receiving part of a document redacted part displaying system according to the third example embodiment of the present invention.

FIG. 13 is a diagram illustrating a configuration of a document redacted part displaying system according to a fourth example embodiment of the present invention.

FIG. 14 is a diagram illustrating a configuration of a redaction processing part and a redacted part change history storage part of a document redacted part displaying system according to the fourth example embodiment of the present invention.

FIG. 15 is a diagram illustrating a configuration of a document redacted part displaying system according to a fifth example embodiment of the present invention.

FIG. 16 is a diagram illustrating a configuration of a redaction processing part according to a sixth example embodiment of the present invention.

FIG. 17 is a diagram illustrating an example of displaying redacted reason of a document redacted part displaying system according to the sixth example embodiment of the present invention.

FIG. 18 is a diagram illustrating a configuration of a redaction processing part according to a seventh example embodiment of the present invention.

FIG. 19 is a diagram illustrating an example of a list display of redacted parts of a document redacted part displaying system according to the seventh example embodiment of the present invention.

FIG. 20 is a diagram illustrates a configuration of a computer making up a document redacted part displaying system of the present invention.

### EXAMPLE EMBODIMENTS

First, an outline of an example embodiment of the present invention will be described with reference to drawings. Note, in the following outline, reference signs of the drawings are denoted to each element as an example for the sake of convenience to facilitate understanding and it is not intended to limit the present invention to embodiments as shown in the drawings. An individual connection line between blocks in drawings referred in the description below includes both one-way and two-way directions. A one-way arrow schematically illustrates a principal signal (data) flow and does not exclude bidirectionality.

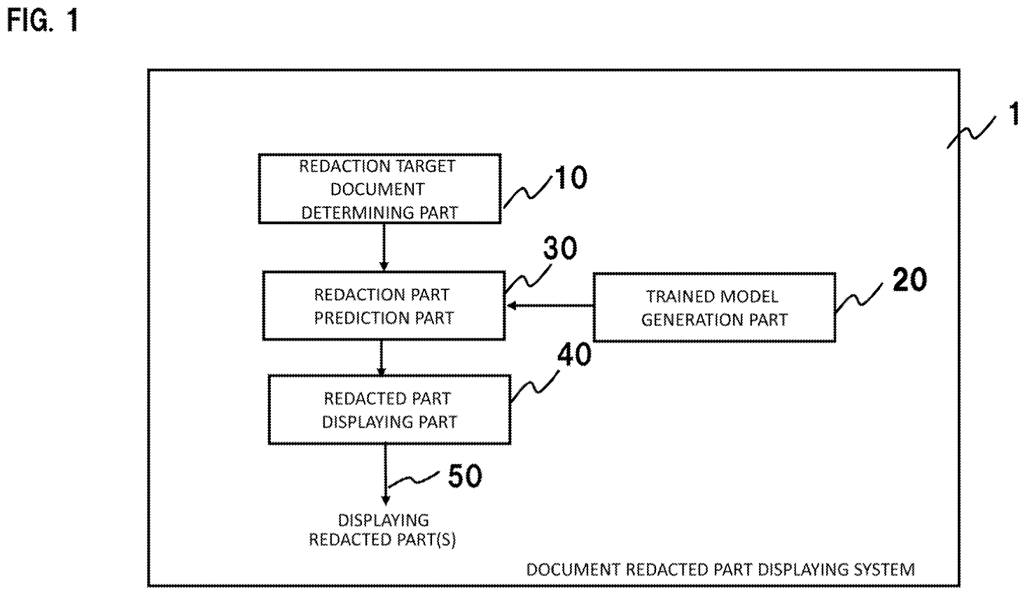

In the example embodiment, as shown in FIG. 1, the present invention can be realized by a document redacted part displaying system 1 which includes a redaction target document determining part 10, a trained model generation part 20, a redaction part prediction part 30, and a redacted part displaying part 40.

More concretely, the redaction target document determining part in the document redacted part displaying system 1 determines a redaction target document which entails an inputted text that is inputted. The trained model generation part 20 generates a trained model by training (learning) a model using one or more documents and labels that designates a redacted part(s) in the document(s) as training data. Please note that, in training of the model, the trained model is generated by adjusting weight parameters of a neural network in such a way that errors between redacted parts predicted by the neural network to which the one or more documents in the training data are inputted and labels of redacted parts for each of the documents become minimum. The redaction part prediction part 30 predicts and outputs a part(s) to be redacted in the redaction target document determined by the redaction target document determining part 10 with using the generated trained model. The redacted part displaying part 40 displays predicted redacted part(s) in the redaction target document.

Please note that it is possible to generate a different trained model corresponding to respective policies, by training models to respective training data of a plurality of groups, whose policies are different from each other, for each predetermined agency, each organization or each division, for example, for each ministry, each office, or each minister. That is to say, if training data including one or more documents and labels designating a redacted part(s) in the document(s), for each ministry, each office, or each minister according to the policy to generate a redaction document(s) is(are) prepared as training data for training a model and then the model is trained, it is possible to generate a trained model adapted to a different redaction policy for each ministry, each office, or each minister and to predict and output redacted parts adapted to each ministry, each office, or each minister by the trained model, and display the redacted parts.

Therefore, it is possible to output and display a redacted part(s) adapted to a policy for each ministry, each office, or each minister to an official document, and recommend a redacted part(s).

Furthermore, in the present example embodiment, a neural network can be a deep neural network. Furthermore, in the present example embodiment, a neural network can be an RNN (Recurrent Neural Network), an LSTM (Long Short Term Memory), a CNN (Convolutional Neural Network) or any combination of an RNN, an LSTM and a CNN.

Furthermore, a redaction target document can be a document including text, a document including a moving image(s), or a document including both text and a moving image(s). Furthermore, a redaction target document can be a document obtained by speech recognition facilities.

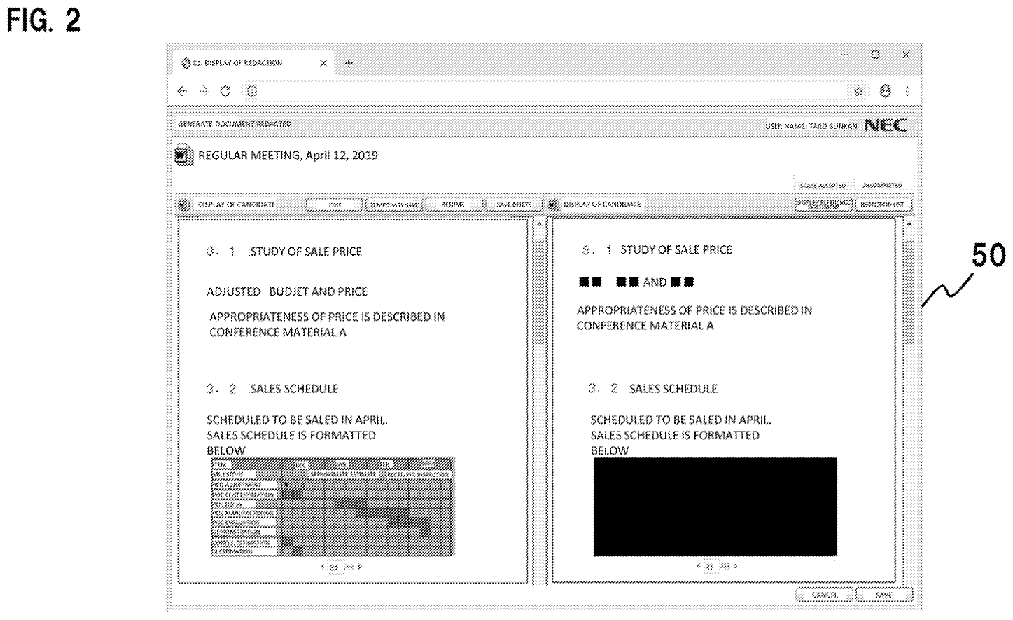

FIG. 2 is a diagram illustrating an operation of a redacted part displaying part of the document redacted part displaying system according to the example embodiment of the present invention. FIG. 2 shows an example embodiment of a display screen 50, in which a redaction target document determined by the redaction target document determining part 10 of the document redacted part displaying system 1 is displayed at a lower left part and a document displaying a redacted part(s) predicted by the redaction part prediction part 30 on the redaction target document is displayed at a lower right part, in parallel. Words of “budget”, “price” and “adjusted” and “a formatted sales schedule” in the redaction target document displayed at the lower left part are redacted on the document displayed at the lower right part.

As described above, according to the document redacted part displaying system of the example embodiment of the present invention, because a part(s) to be redacted in a redaction target document can be outputted and displayed using a trained model, it becomes possible to make redaction operations of a document more efficient and save the number of labors. Furthermore, it becomes possible to recommend a redacted part(s) in a document adapted to a redaction policy of documents for each predetermined agency, each organization or each division, such as, for example, for each ministry, each office, or each minister.

### First Example Embodiment

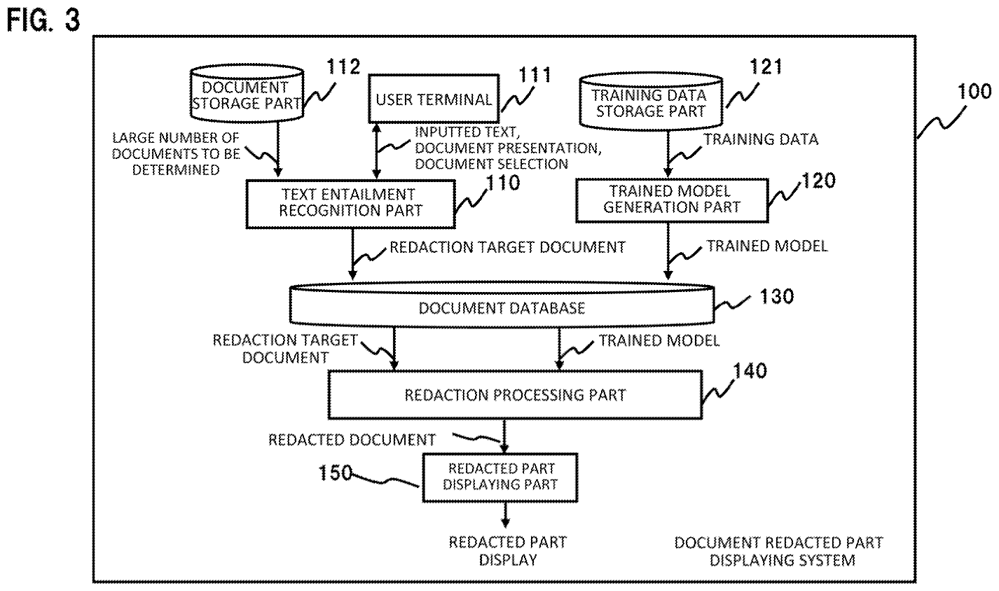

Next, a document redacted part displaying system according to a first example embodiment of the present invention will be described with reference to drawings. FIG. 3 is a diagram illustrating a configuration of a document redacted part displaying system according to the first example embodiment of the present invention. With reference to FIG. 3, a configuration including a text entailment recognition part 110, a user terminal 111, a document storage part 112, a trained model generation part 120, a training data storage part 121, a document database 130, a redaction processing part 140, and a redacted part displaying part 150.

The document storage part 112 stores candidate documents of redaction target documents. The text entailment recognition part 110 includes a text entailment recognition function for extracting, for each of a plurality of single sentences included in an input text, single sentences each of which has a similar meaning to each of the single sentences included in the input text, from a document including a plurality of single sentences:
generating discourse relation information indicating a discourse relation which is an occurrence order of events between single sentences based on the appearance order of single sentences before and after a certain connection word for each of the input text and the document:
calculating, based on the discourse relation information, a discourse relation distance which is the number of intersections of positions between the discourse relation between the single sentences included in the document and the single sentences extracted: and
determining, based on a value including the discourse relation distance and a predetermined threshold value, whether or not the document entails the input text. The text entailment recognition method is described in PTL 4. The text entailment recognition part 110 determines a document which entails inputted text supplied from the user terminal 111 among document stored in the document storage part 112 as a redaction target document. The determined redaction target document is stored in the document database 130.

The trained model generation part 120 trains a model using training data including one or more documents and labels that designates a redacted part(s) in the document(s) stored in the training data storage part 121. Please note that operations to train a model by the trained model generation part 120 are the same as those by the trained model generation part 20 as described in the example embodiment above. The trained model generated by the trained model generation part 120 is stored in the document database 130. Please note that, because the training data of a plurality of groups whose policies are different from each other, for each predetermined agency, each organization or each division, for example, for each ministry, each office, or each minister are stored in the training data storage part 121, as described in the example embodiment, it is possible to generate a respective different trained model by respectively training model to the training data of respective groups and to store a plurality types of trained models with different policies in the document database 130.

The redaction processing part 140 predicts a part(s) to be redacted in the redaction target document stored in the document database 130 using the trained model stored in the document database 130, determines a part(s) to be redacted, and outputs a redacted document including the determined redacted part(s). The redaction processing part 140 can predicts a parts(s) to be redacted using a trained model applied to a redaction target document among respective different trained models for a plurality of groups, whose policy are different from each other, for each predetermined agency, each organization or each division, for example, for each ministry, each office, or each minister. The redacted part displaying part 150 displays the redacted document outputted by the redaction processing part 140.

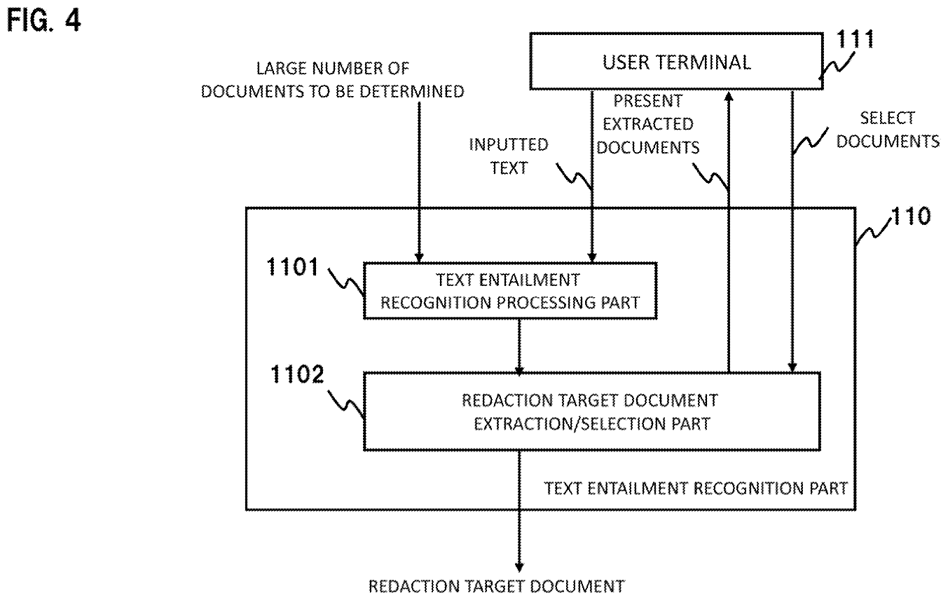

FIG. 4 is a diagram illustrating a configuration of a text entailment recognition part of the document redacted part displaying system according to the first example embodiment of the present invention. The text entailment recognition part 110 includes a text entailment recognition processing part 1101 and a redaction target document extraction/selection part 1102. The text entailment recognition processing part 1101 is supplied with inputted text from the user terminal 111, determines and extracts a document which entails the inputted text among a large number of documents to be determined stored in the document storage part 112, and sends an extracted document to the redaction target document extraction/selection part 1102. The redaction target document extraction/selection part 1102 present the extracted document to the user terminal. Correspondingly, selection of a document is sent from the user terminal to the redaction target document extraction/selection part 1102, and according to the selection, the redaction target document extraction/selection part 1102 determines the extracted document as a redaction target document. The determined redaction target document is stored in the document database 130.

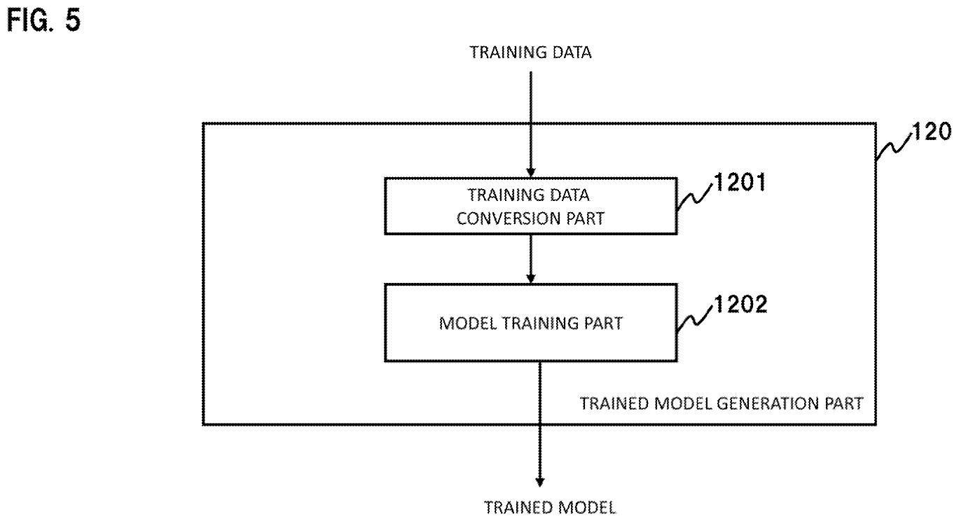

FIG. 5 is a diagram illustrating a configuration of a trained model generation part of the document redacted part displaying system according to the first example embodiment of the present invention. The trained model generation part 120 includes a training data conversion part 1201 and a model training part 1202. The training data conversion part 1201 performs a pre-processing to convert the training data to a type of data which the model training part 1202 uses to train a model. Examples of the pre-processings include, but not limited to, conversion of words in a redaction target document to their distributed representations of words, and so on. The model training part 1202 trains a model using training data inputted from the training data conversion part 1201. Please note that operations to train a model by the model training part 1202 are the same as those by the trained model generation part 20 as described in the example embodiment.

Please note that a distributed representation of a word is a method to represent meaning of a word by a high dimensional real number vector, and methods such as word2vex, GloVe (Global Vectors for Word Representation), fastText, BERT (Bidirectional Encoder Representations from Transformers), and so on are known.

Please note that property of a distributed representation depends on text (corpus) used for training (learning). Therefore, the training data conversion part 1201 may convert words in a redaction target document using distributed representations obtained by training using corpus related to administrative document(s).

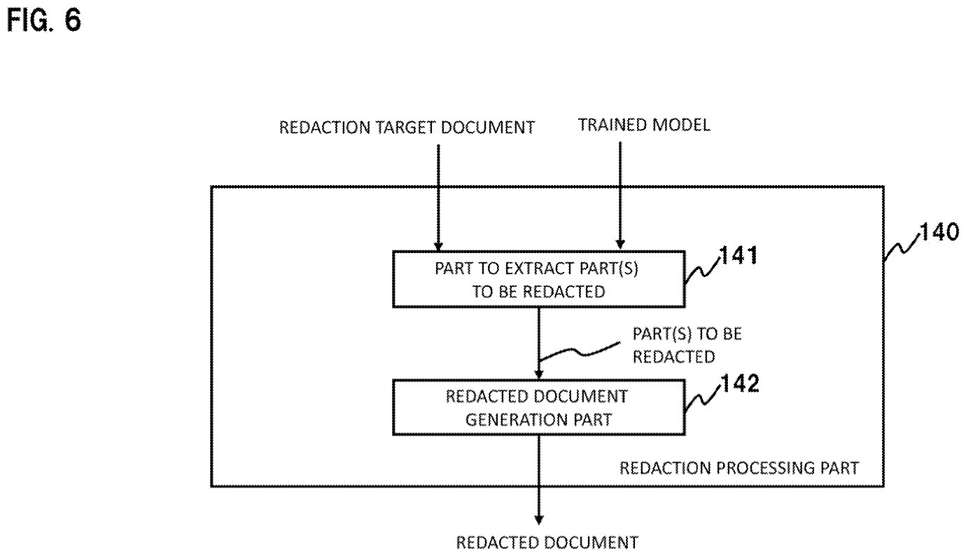

FIG. 6 is a diagram illustrating a configuration of a redaction processing part of the document redacted part displaying system according to the first example embodiment of the present invention. The redaction processing part 140 includes a part to extract a part(s) to be redacted 141 and a redacted document generation part 142. The part to extract a part(s) to be redacted 141 predicts, to an inputted redaction target document, a part(s) to be redacted in the redaction target document using a trained model and determines a part (s) to be redacted. The redacted document generation part 142 generates and outputs a redacted document including the determined part(s) to be redacted.

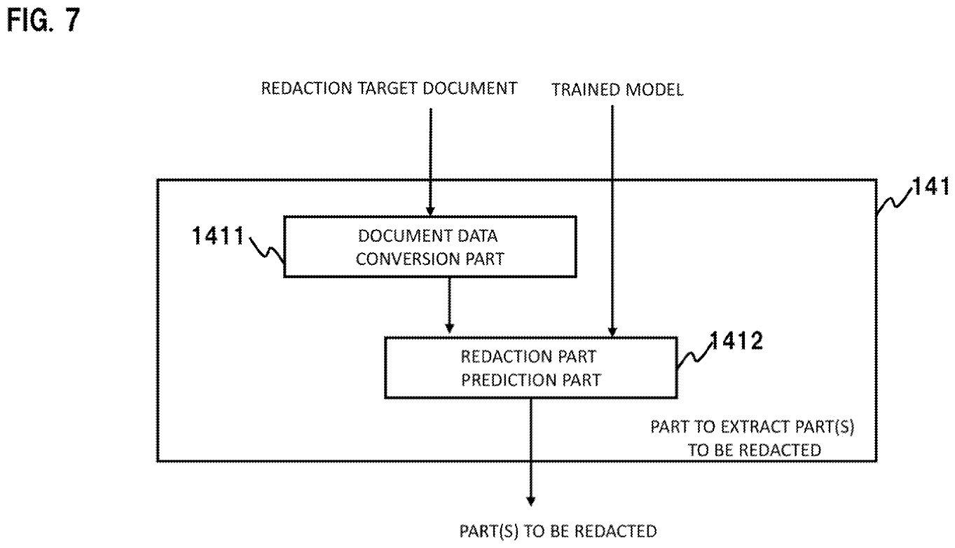

FIG. 7 is a diagram illustrating a configuration of a part to extract a part(s) to be redacted of the document redacted part displaying system according to the first example embodiment of the present invention. The part to extract a part(s) to be redacted 141 includes a document data converion part 1411 and a redaction part prediction part 1412. In the redaction part prediction part 1412, a trained model is set. The document data converion part 1411 performs a pre-processing to convert a redaction target document to a type of data which the redaction part prediction part 1412 uses for prediction. In this pre-processing, processing corresponding to the pre-processing to training data performed in the training data conversion part 1201 is also performed to a redaction target document. The redaction part prediction part 1412 supplies the redaction target document inputted from the document data converion part 1411 to the trained model, predicts a part(s) to be redacted, and determines and outputs the part(s) to be redacted.

### Second Example Embodiment

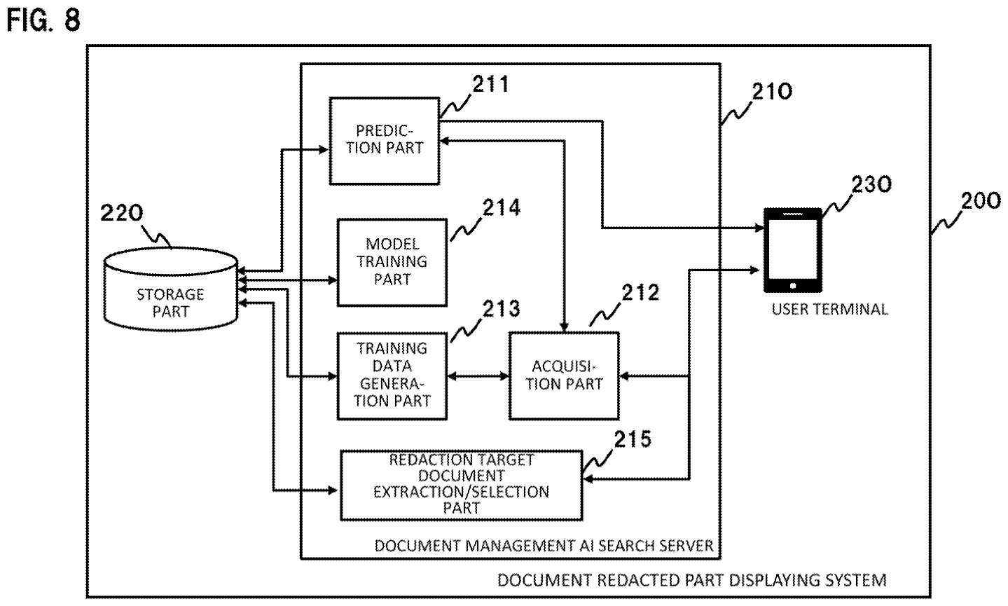

Next, a second example embodiment of the present invention will be described with reference to drawings. FIG. 8 is a diagram illustrating a configuration of a document redacted part displaying system according to the second example embodiment of the present invention. A document redacted part displaying system 200 of the second example embodiment includes a document management AI search server 210, a storage part 220, and a user terminal 230. The document management AI search server 210 includes a prediction part 211, an acquisition part 212, a training data generation part 213, a model training part 214, and a redaction target document extraction/selection part 215. The redaction target document extraction/selection part 215 includes a text entailment recognition function which determines a document which entails inputted text. The text entailment recognition function is the same as previously described.

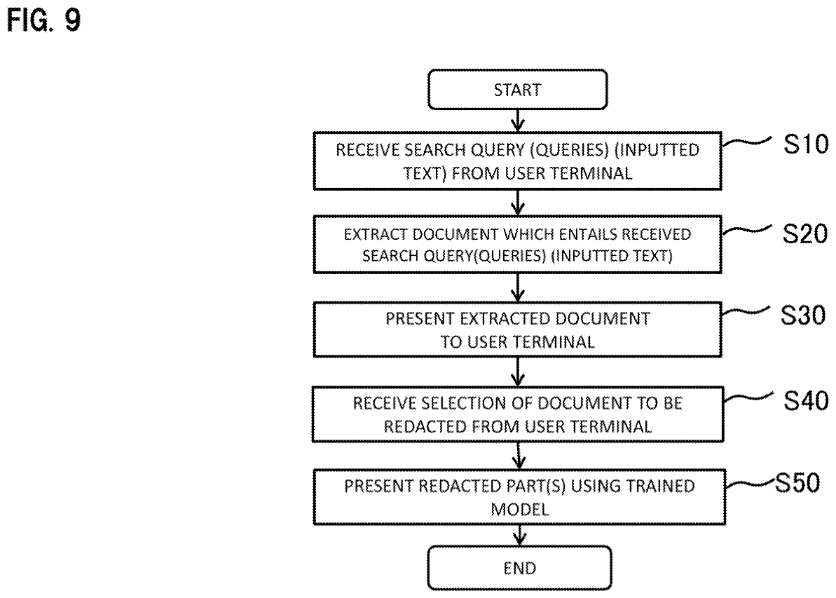

FIG. 9 is a diagram illustrating a flow chart describing an operation of the document redacted part displaying system according to the second example embodiment of the present invention. In step S10, the redaction target document extraction/selection part 215 receives a search query (queries) (inputted text) from the user terminal 230. Next, in step S20, the redaction target document extraction/selection part 215 extracts a document which entails the received search query (queries) (the inputted text) from the storage part 220 by using the text entailment recognition function. Next, in step S30, the redaction target document extraction/selection part 215 presents the extracted document to the user terminal. In step S40, the acquisition part 212 receives selection of a document to be redacted from the user terminal 230. Then, in step S50, the prediction part 211 presents the redacted part(s) for the redaction target document, using a trained model.

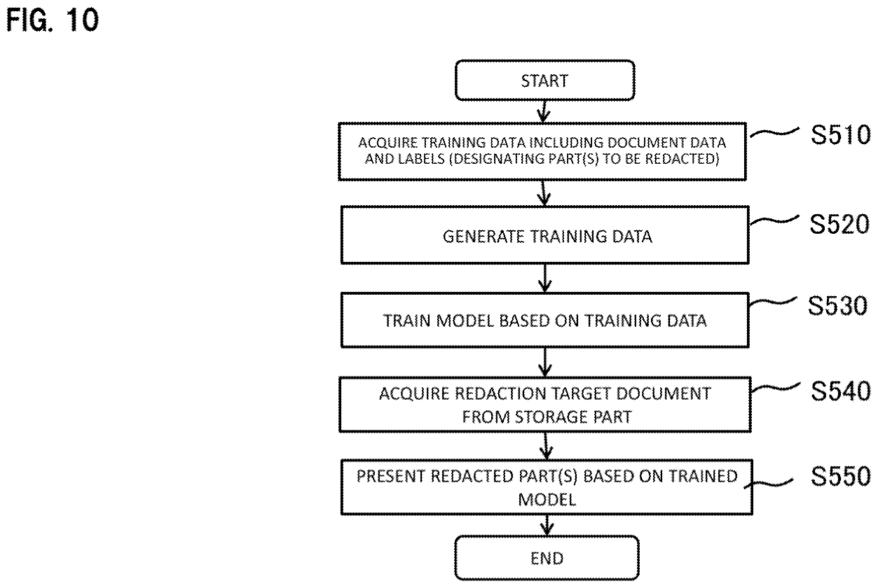

FIG. 10 is a diagram illustrating a flow chart describing an operation of the document redacted part displaying system according to the second example embodiment of the present invention. The flow chart shown in FIG. 10 is a diagram further describing in detail the operation of the step S50 in the flow chart as shown in FIG. 9. In step S510, the acquisition part 212 acquires training data including document data and labels (designating part(s) to be redacted) from the user terminal 230. Next, in step S520, the training data generation part 213 generates training data to be used for training in the model training part 214. Please note that the training data generation part 213 is also possible to generate respective training data for each of a plurality of groups for each predetermined agency, each organization or each division, for example, for each ministry, each office, or each minister. Next, in step S530, the model training part 214 generates a trained model by training a model based on the training data and stores the trained model in the storage part 220. Please note that, in training of the model by the model training part 214, the trained model is generated by adjusting weight parameters of a neural network in such a way that errors between redacted parts predicted by the neural network to which the one or more documents in the training data are inputted and labels of redacted parts for each of the documents become minimum. Please note that the model training part 214 trains models based on the training data for respective groups of a plurality of groups for each ministry, each office, or each minister, generated by the training data generation part 213, generates respective trained models for a plurality of groups for each ministry, each office, or each minister, and stores the trained models in the storage part 220.

Next, in step S540, a redaction target document which is a prediction target selected from the user terminal 230 via the acquisition part 212 in the step S40 as shown in FIG. 9 is read out from the storage part 220 to the prediction part 211. Next, in step S550, the acquisition part 212 receives designation of a trained model to be used for prediction from the user terminal 230. The acquisition part 212 designates the trained model to be used to the prediction part 211 and the prediction part 211 reads out the trained model to be used for the prediction from the storage part 220. Then, the prediction part 211 predicts a part(s) to be redacted of the read out redaction target document based on the read-out trained model and presents the redacted part(s).

### Third Example Embodiment

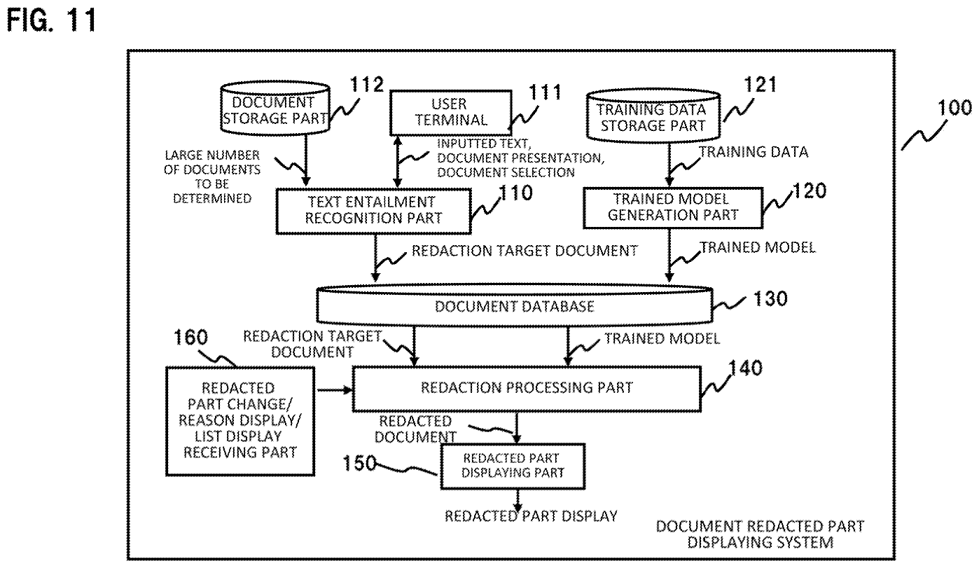

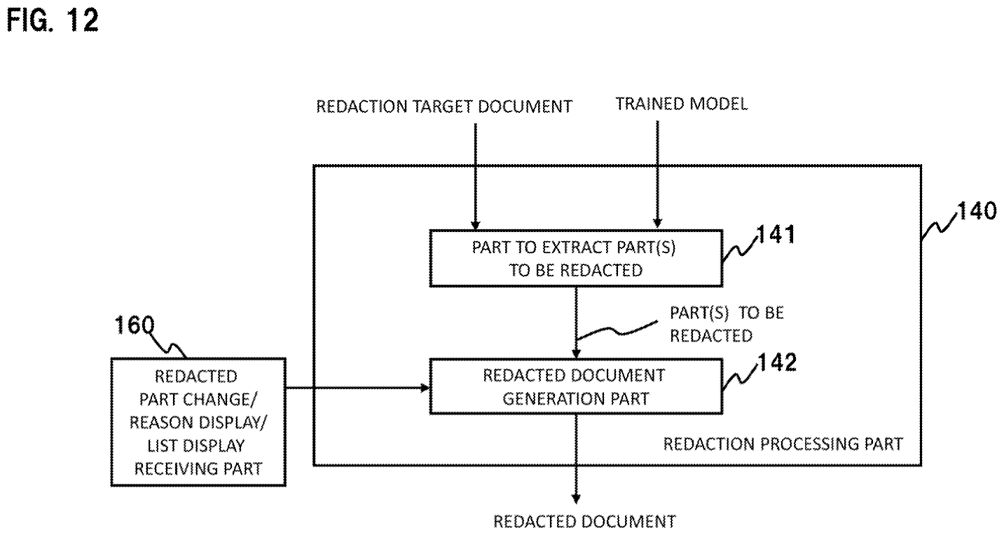

Next, a third example embodiment of the present invention will be described with reference to drawings. FIG. 11 is a diagram illustrating a configuration of a document redacted part displaying system according to the third example embodiment of the present invention. In FIG. 11, elements denoted by the same reference numerals as those in FIG. 3 are the same elements. The third example embodiment of the present invention is an example embodiment obtained by adding a redacted part change/reason display/list display receiving part 160 to the configuration of the document redacted part displaying system according to the first example embodiment of the present invention as shown in FIG. 3. Furthermore, FIG. 12 is a diagram illustrating a configuration of a redaction processing part and a redacted part change/reason display/list display receiving part of a document redacted part displaying system according to the third example embodiment of the present invention. In FIG. 12, elements denoted by the same reference numerals as those in FIG. 6 are the same elements. A difference between the third example embodiment and the first example embodiment will be mainly described below. A redaction processing part 140 of the third example embodiment as shown in FIG. 12 receives at a redacted document generation part 142 a redacted part change instruction outputted from a redacted part change/reason display/list display receiving part 160, and, according to the instruction, the redacted document generation part 142 performs processing to delete the redacted part(s) determined by a part to extract a part(s) to be redacted 141, or to set a redacted part(s) at different part(s), and so on. According to the third example embodiment of the present invention, it is possible to change a redacted part(s) determined by the part to extract a part(s) to be redacted 141.

### Fourth Example Embodiment

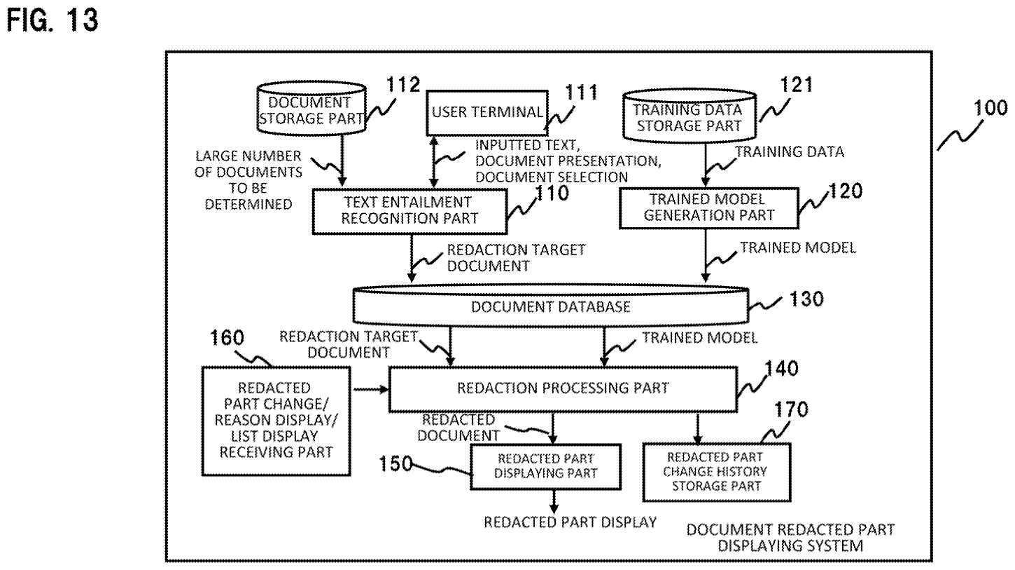

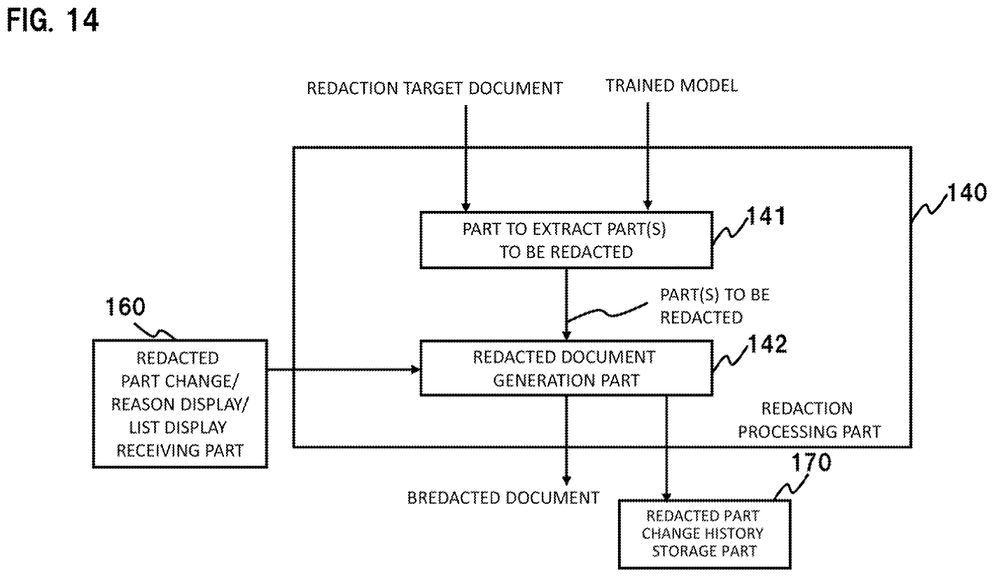

Next, a fourth example embodiment of the present invention will be described with reference to drawings. FIG. 13 is a diagram illustrating a configuration of a document redacted part displaying system according to the fourth example embodiment of the present invention. In FIG. 13, elements denoted by the same reference numerals as those in FIG. 11 are the same elements. The fourth example embodiment of the present invention is an example embodiment obtained by adding a redacted part change history storage part 170 to the configuration of the document redacted part displaying system according to the third example embodiment of the present invention as shown in FIG. 11. Furthermore, FIG. 14 is a diagram illustrating a configuration of a redaction processing part and a redacted part change history storage part of a document redacted part displaying system according to the fourth example embodiment of the present invention. In FIG. 14, elements denoted by the same reference numerals as those in FIG. 12 are the same elements. A difference between the fourth example embodiment and the third example embodiment will be mainly described below. A redaction processing part 140 of the fourth example embodiment as shown in FIG. 14 receives at a redacted document generation part 142 an instruction outputted from a redacted part change/reason display/list display receiving part 160, and, according to the instruction, the redacted document generation part 142 can change a redacted part(s) determined by the part to extract a part(s) to be redacted 141. The redacted part change history storage part 170 stores the change history along with the redaction target document when the redacted document generation part 142 has changed the redacted part(s) determined by the part to extract a part(s) to be redacted 141. The change history of the redacted part(s) thus accumulated can be used as training data for generating a trained model(s) by the trained model generation part 120 if a predetermined number of change histories are accumulated.

### Fifth Example Embodiment

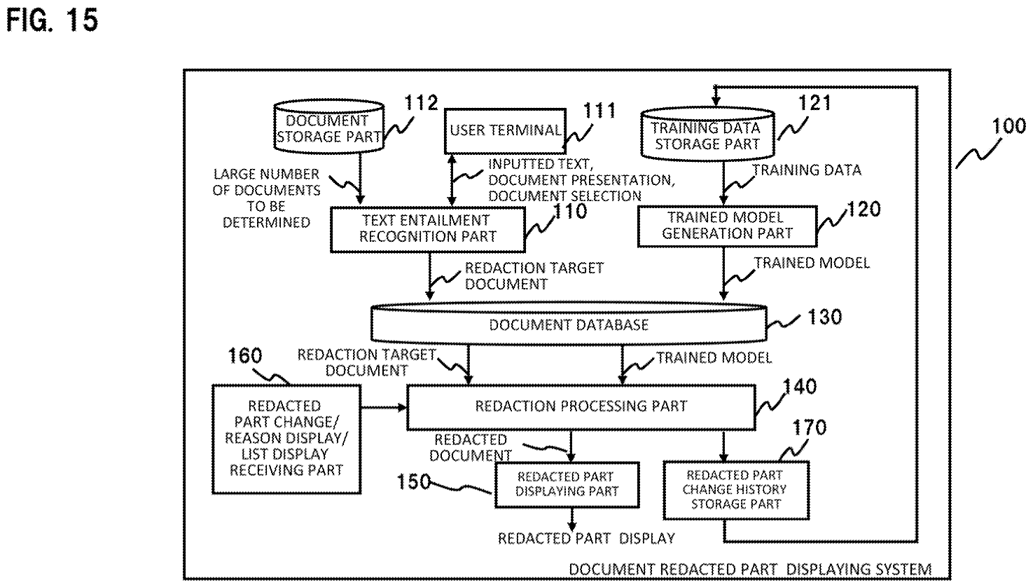

Next, a fifth example embodiment of the present invention will be described with reference to drawings. FIG. 15 is a diagram illustrating a configuration of a document redacted part displaying system according to the fifth example embodiment of the present invention. In FIG. 15, elements denoted by the same reference numerals as those in FIG. 13 are the same elements. The fifth example embodiment of the present invention is an example embodiment obtained by adding a connection from a redacted part change history storage part 170 to a training data storage part 121 to the configuration of the document redacted part displaying system according to the fourth example embodiment of the present invention as shown in FIG. 13. A difference between the fifth example embodiment and the fourth example embodiment will be mainly described below. The redacted part change history storage part 170 stores the change history along with the redaction target document when the redacted document generation part 142 has changed the redacted part(s) determined by the part to extract a part(s) to be redacted 141. If a predetermined number of thus accumulated change histories of the redacted part(s) are accumulated, accumulated redaction target documents and the accumulated change histories of the redacted part(s) are sent from the redacted part change history storage part 170 to the training data storage part 121. The training data storage part 121 stores the sent redaction target documents and the change histories of the redacted part(s) as re-training data and the trained model generation part 120 can re-generate a trained model by training a model again using these accumulated re-training data.

### Sixth Example Embodiment

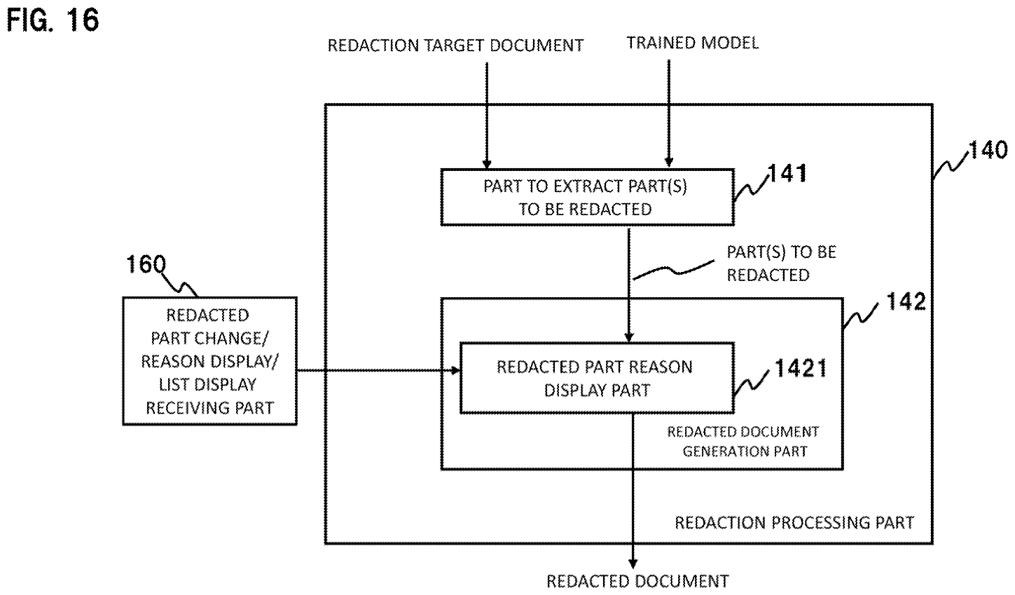

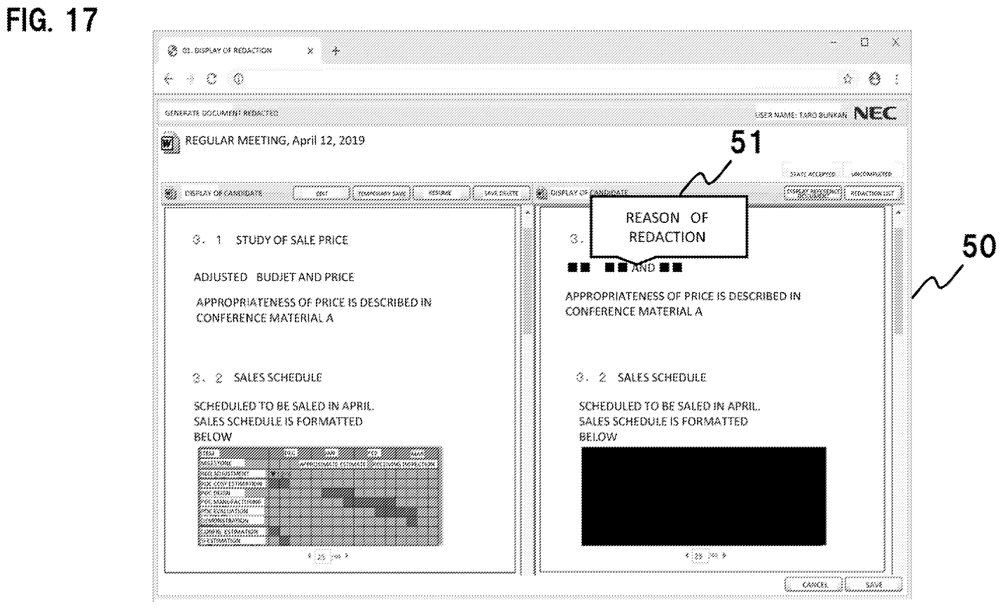

Next, a sixth example embodiment of the present invention will be described with reference to drawings. FIG. 16 is a diagram illustrating a configuration of a redaction processing part according to the sixth example embodiment of the present invention, which is obtained by changing the configuration of the redaction processing part as shown in FIG. 12 according to the third example embodiment of the present invention. The redaction processing part 140 according to the sixth example embodiment of the present invention as shown in FIG. 16 includes a redacted part reason display part 1421 in a redacted document generation part 142. FIG. 17 is a diagram illustrating an example of displaying a redacted part(s) of a document redacted part displaying system according to the sixth example embodiment of the present invention. In FIG. 17, elements denoted by the same reference numerals as those in FIG. 2 are the same elements. Please note that because a trained model used to predict a redacted part(s) of a redaction target document has been respectively generated by using respective training data to a plurality of groups, for each predetermined agency, each organization or each division, for example, for each ministry, each office, or each minister, respective trained models correspond to respective policies. The redacted part reason display part 1421 receives the extracted redacted part(s) and a reason(s) of the redaction corresponding to policies concerning trained data at the time of generating the trained model and holds them. In the sixth example embodiment of the present invention, when a redacted part is designated by a pointing device, such as for example, a mouse and so on, on the document shown in a lower right part on the display screen 50 as shown in FIG. 17, designation of the redacted part is received by a redacted part change/reason display/list display receiving part 160 and it is sent to a redacted document generation part 142. The redacted document generation part 142 sends the redacted document along with the reason(s) of the redaction corresponding to respective redacted part(s) held in the redacted part reason display part 1421 to a redacted part displaying part 150, and the redacted part displaying part 150 displays the reason of the redaction 51 on the display screen 50.

### Seventh Example Embodiment

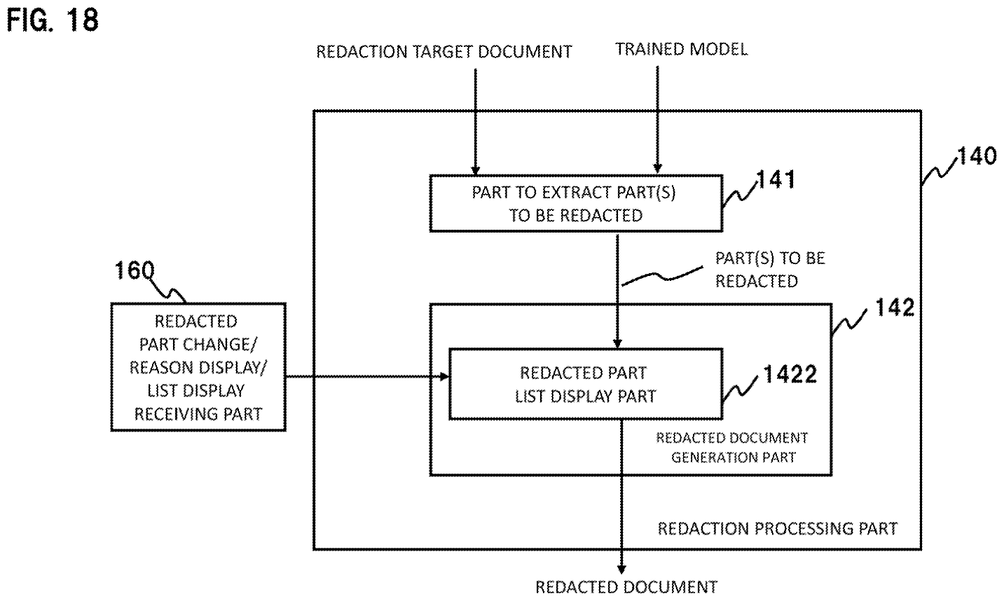

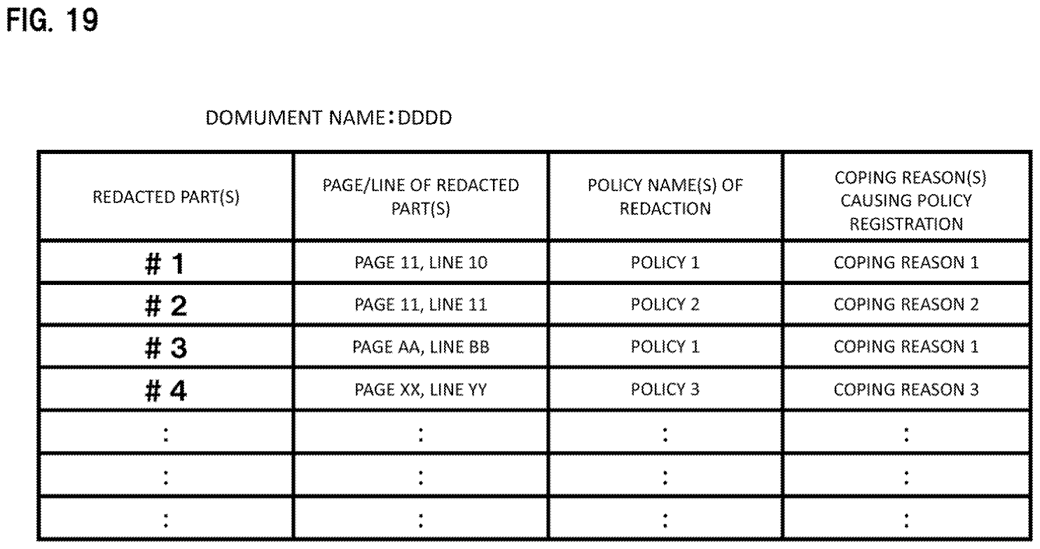

Next, a seventh example embodiment of the present invention will be described with reference to drawings. FIG. 18 is a diagram illustrating a configuration of a redaction processing part according to the seventh example embodiment of the present invention, which is obtained by changing the configuration of the redaction processing part as shown in FIG. 12 according to the third example embodiment of the present invention. The redaction processing part 140 according to the seventh example embodiment of the present invention as shown in FIG. 18 includes a redacted part list display part 1422 in a redacted document generation part 142. FIG. 19 is a diagram illustrating an example of a list display of redacted parts of a document redacted part displaying system according to the seventh example embodiment of the present invention. While not limited to contents as shown in FIG. 19, for example, a redacted part number, a page/line of the redacted part(s), a policy name(s) of the redacted, and a coping reason(s) causing policy registration may be displayed. Please note that because a trained model used to predict a redacted part(s) of a redaction target document has been respectively generated by using respective training data to a plurality of groups, for each predetermined agency, each organization or each division, for example, for each ministry, each office, or each minister, respective trained models correspond to respective policies. The redacted part list display part 1422 receives the extracted redacted part(s) and the policy name(s) of the redacted and the coping reason(s) causing policy registration corresponding to policies concerning trained data at the time of generating the trained model, and may hold them in a list format. When the redacted part change/reason display/list display receiving part 160 receives a designation of a list display, the designation of a list display is sent to the redacted part list display part 1422, and the list of the redacted parts(s) corresponding to respective redacted part(s) held in the redacted part list display part 1422 is sent to the redacted part displaying part 150, then the list of the redacted parts(s) is displayed.

The example embodiments of the present invention have been described as above, however, the present invention is not limited thereto. Further modifications, substitutions, or adjustments can be made without departing from the basic technical concept of the present invention. For example, the configurations of the networks and the elements and the representation modes of the messages illustrated in the individual drawings are merely used as examples to facilitate the understanding of the present invention. Thus, the present invention is not limited to the configurations illustrated in the drawings. In addition, “A and/or B” in the following description signifies at least one of A or B.

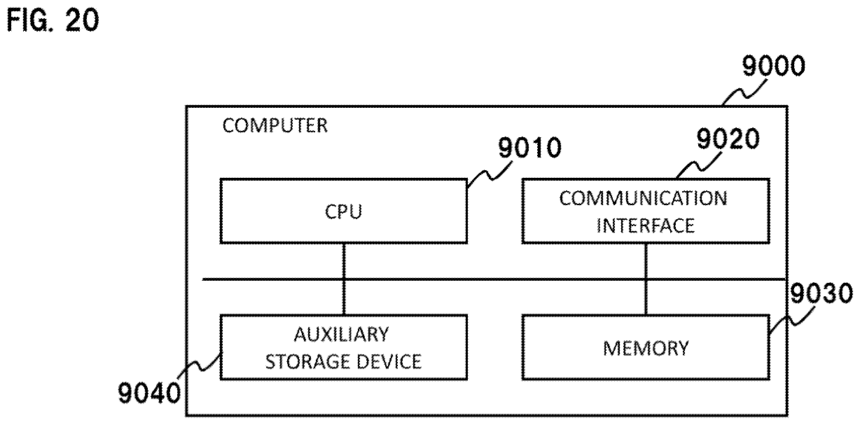

The procedures according to the first to seventh example embodiments can be realized by a program that causes a computer (9000 in FIG. 20) functioning as a document redacted part displaying system 1, 100 and 200 to realize functions as the document redacted part displaying system 1, 100 and 200. Such computer is illustrated by a configuration, as an example, including a CPU (Central Processing Unit) 9010, a communication interface 9020, a memory 9030, and an auxiliary storage device 9040 as shown in FIG. 20. Namely, the CPU 9010 in FIG. may be configured to execute a document redacted part displaying program and to perform processing for updating various calculation parameters stored in the auxiliary storage device 9040 or the like.

Namely, an individual part (processing means, function) of the document redacted part displaying system according to the above first to seventh example embodiments may be realized by a computer program that causes a processor of the computer to perform the corresponding processing described above by using its hardware.

Finally, suitable modes of the present invention will be summarized.

### [Mode 1]

(See the document redacted part displaying system according to the above first aspect)

### [Mode 2]

It is preferable that the trained model generation part of the above-described document redacted part displaying system generates a different trained model respectively to the training data for a plurality of groups of each predetermined public agency, each organization or each division.

[Mode 3]

It is preferable that the redacted part displaying part of the above-described document redacted part displaying system displays the redaction target document and the redacted part(s) in the redaction target document.

[Mode 4]

It is preferable that the trained model generation part of the above-described document redacted part displaying system trains a model using a neural network.

### [Mode 5]

It is preferable that the neural network of the above-described document redacted part displaying system is a deep neural network.

### [Mode 6]

It is preferable that the neural network of the above-described document redacted part displaying system is an RNN (Recurrent Neural Network), an LSTM (Long Short Term Memory), a CNN (Convolutional Neural Network), or any combination of an RNN, an LSTM and a CNN.

### [Mode 7]

It is preferable that the redaction target document determining part of the above-described document redacted part displaying system determines a redaction target document from among documents including sentences entailing the inputted text in stored one or more document(s) using an entailment recognition method including: extracting, for each of a plurality of single sentences included in an input text, single sentences each of which has a similar meaning to each of the single sentences included in the input text, from a document including a plurality of single sentences:
generating discourse relation information indicating a discourse relation which is an occurrence order of events between single sentences based on the appearance order of single sentences before and after a certain connection word for each of the input text and the document:
calculating, based on the discourse relation information, a discourse relation distance which is the number of intersections of positions between the discourse relation between the single sentences included in the document and the single sentences extracted: and
determining, based on a value including the discourse relation distance and a predetermined threshold value, whether or not the document entails the input text.

### [Mode 8]

It is possible to further include: a redacted part change accepting part which accepts change of display of the redacted part in the redaction target document.

### [Mode 9]

(See the document redacted part displaying method according to the above second aspect)

### [Mode 10]

(See the document redacted part displaying program according to the above third aspect)

### [Mode 11]

It is preferable that a redaction target document in the above-described document redacted part displaying system can be a document including text.

### [Mode 12]

It is possible that a redaction target document in the above-described document redacted part displaying system can be a document including a moving image(s).

### [Mode 13]

It is possible that a redaction target document of the above-described document redacted part displaying system can be a document obtained by speech recognition facilities.

### [Mode 14]

It is preferable that the redacted document generation part changes a redacted part(s) determined by the part to extract a part(s) to be redacted according to an input received by the redacted part change receiving part of the above-described document redacted part displaying system.

### [Mode 15]

It is possible to further include the redacted part change history storage part which stores change of display of the redaction parts of the above-described document redacted part displaying system as the change history.

### [Mode 16]

It is preferable that the trained model generation part of the above-described document redacted part displaying system can train a model again using re-training data in which history information stored in the redacted part change history storage part is used as labels.

### [Mode 17]

It is possible that the redacted part reason display receiving part can receive an input to designate a redacted part(s) of a redaction target document.

### [Mode 18]

It is possible that the redacted part displaying part of the above-described document redacted part displaying system can display the reason of the redaction part(s) held in the redacted part reason display part according to an input received by the redacted part reason display receiving part.

### [Mode 19]

It is possible that the redacted part list display receiving part can receive an input to designate a list display of the redacted part(s).

[Mode 20]

It is possible that the redacted part displaying part of the above-described document redacted part displaying system can display the list of the redacted parts(s) held in the redacted part list display part according to the input received by the redacted part list display receiving part.

### [Mode 21]

It is possible that in the redacted part list of the above-described document redacted part displaying system can display redacted part, a page/line of the redacted part(s), a policy name(s) associated with each redacted part, and a coping reason(s) causing policy registration.

The disclosure of each of the above Patent Literatures is incorporated herein by reference thereto. Variations and adjustments of the example embodiments and examples are possible within the scope of the overall disclosure (including the claims) of the present invention and based on the basic technical concept of the present invention. Various combinations and selections of various disclosed elements (including the elements in each of the claims, example embodiments, examples, drawings, etc.) are possible within the scope of the disclosure of the present invention. Namely, the present invention of course includes various variations and modifications that could be made by those skilled in the art according to the overall disclosure including the claims and the technical concept. In particular, with respect to the numerical ranges described herein, any numerical values or small range(s) included in the ranges should be construed as being expressly described even if not particularly mentioned.

### REFERENCE SIGNS LIST

1, 100, 200 document redacted part displaying system
10 redaction target document determining part
20 trained model generation part
30 redaction part prediction part
40 redacted part displaying part
110 text entailment recognition part
111 user terminal
112 document storage part
120 trained model generation part
121 training data storage part
130 document database
140 redaction processing part
141 part to extract a part(s) to be redacted
142 redacted document generation part
150 redacted part displaying part
160 redacted part change/reason display/list display receiving part
170 redacted part change history storage part
210 document management AI search server
211 prediction part
212 acquisition part
213 training data generation part
214 model training part
215 redaction target document extraction/selection part
220 storage part
230 user terminal
1101 text entailment recognition processing part
1102 redaction target document extraction/selection part
1201 training data conversion part
1202 model training part
1411 document data converion part
1412 redaction part prediction part
1421 redacted part reason display part
1422 redacted part list display part
9000 computer
9010 CPU
9020 communication interface
9030 memory
9040 auxiliary storage device

What is claimed is:

1. A document redacted part displaying system, comprising:
at least a processor; and
a memory in circuit communication with the processor,
wherein the processor is configured to execute program instructions stored in the memory to implement:
a redaction target document determining part which determines a redaction target document which entails an inputted text;
a trained model generation part which generates a trained model by training a model using one or more documents and labels that designates a redacted part(s) in the document(s) as training data;
a redaction part prediction part which predicts and outputs a part(s) to be redacted in the redaction target document by the trained model;
a redacted part displaying part which displays the redacted part(s) in the redaction target document; and
a redacted part change receiving part which receives a delete instruction of the displayed redacted part(s) or an addition instruction of a different redacted part(s) from the displayed redacted part(s).

2. The document redacted part displaying system according to claim 1, wherein the trained model generation part generates a different trained model respectively to the training data for a plurality of groups of each predetermined public agency, each organization or each division.

3. The document redacted part displaying system according to claim 1, wherein the redacted part displaying part displays the redaction target document and the redacted part(s) in the redaction target document.

4. The document redacted part displaying system according to claim 1, wherein the trained model generation part trains a model using a neural network.

5. The document redacted part displaying system according to claim 4, wherein the neural network is a deep neural network.

6. The document redacted part displaying system according to claim 4, wherein the neural network is an RNN (Recurrent Neural Network), an LSTM (Long Short Term Memory), a CNN (Convolutional Neural Network), or any combination of an RNN, an LSTM and a CNN.

7. The document redacted part displaying system according to claim 1, wherein the redaction target document determining part determines a redaction target document from among documents including sentences entailing the inputted text in stored one or more document(s) using an entailment recognition method comprising:
extracting, for each of a plurality of single sentences included in an input text, single sentences each of which has a similar meaning to each of the single sentences included in the input text, from a document including a plurality of single sentences:
generating discourse relation information indicating a discourse relation which is an occurrence order of events between single sentences based on the appearance order of single sentences before and after a certain connection word for each of the input text and the document:
calculating, based on the discourse relation information, a discourse relation distance which is the number of intersections of positions between the discourse relation between the single sentences included in the input text and the single sentences extracted: and
determining, based on a value including the discourse relation distance and a predetermined threshold value, whether or not the document entails the input text.

8. The document redacted part displaying system according to claim 1,
wherein the trained model generation part updates the trained model by using the redaction target document, the redacted part(s) changed on the basis of the delete instruction or the addition instruction.

9. A document redacted part displaying method, comprising:
determining a redaction target document which entails an inputted text;
generating a trained model by training a model using one or more documents and labels that designates a redacted part(s) in the document(s) as training data;
predicting and outputting a part(s) to be redacted in the redaction target document by the trained model;
displaying the redacted part(s) in the redaction target document; and
receiving a delete instruction of the displayed redacted part(s) or an addition instruction of a different redacted part(s) from the displayed redacted part(s).

10. A computer-readable non-transient recording medium recording a document redacted part displaying program, the program causing a computer comprising a processor and a memory to execute processings, comprising:
determining a redaction target document which entails an inputted text;
generating a trained model by training a model using one or more documents and labels that designates a redacted part(s) in the document(s) as training data;
predicting and outputting a part(s) to be redacted in the redaction target document by the trained model;
displaying the redacted part(s) in the redaction target document; and
receiving a delete instruction of the displayed redacted part(s) or an addition instruction of a different redacted part(s) from the displayed redacted part(s).

11. The document redacted part displaying system according to claim 1,
wherein the redacted part displaying part displays at least one of a redacted part number, a page/line of the redacted part(s), a policy name(s) of the redacted, and a coping reason(s) causing policy registration, corresponding to the redacted part(s).

12. The method according to claim 9, wherein the generating a trained model comprises generating a different trained model respectively to the training data for a plurality of groups of each predetermined public agency, each organization or each division.

13. The method according to claim 9, wherein the displaying the redacted part(s) comprises displaying the redaction target document and the redacted part(s) in the redaction target document.

14. The method according to claim 9, wherein the generating a trained model comprises training a model using a neural network.

15. The method according to claim 9,
wherein the displaying the redacted part(s) comprises displaying at least one of a redacted part number, a page/line of the redacted part(s), a policy name(s) of the redacted, and a coping reason(s) causing policy registration, corresponding to the redacted part(s).

16. The medium according to claim 10, wherein the generating a trained model comprises generating a different trained model respectively to the training data for a plurality of groups of each predetermined public agency, each organization or each division.

17. The medium according to claim 10, wherein the displaying the redacted part(s) comprises displaying the redaction target document and the redacted part(s) in the redaction target document.

18. The medium according to claim 10, wherein the generating a trained model comprises training a model using a neural network.

19. The medium according to claim 10,
wherein the displaying the redacted part(s) comprises displaying at least one of a redacted part number, a page/line of the redacted part(s), a policy name(s) of the redacted, and a coping reason(s) causing policy registration, corresponding to the redacted part(s).
